(19) United States
(12) Patent Application Publication
(10) Pub. No.: US 2011/0146913 A1
(43) Pub. Date: Jun. 23, 2011

(54) INDUSTRIAL FABRIC WITH WEAR RESISTANT COATING

(76) Inventor: William Harwood, Waycross, GA (US)

(21) Appl. No.: 12/646,117

(22) Filed: Dec. 23, 2009

(51) Int. Cl. B32B 37/00; B32B 3/10; B32B 3/02

(52) U.S. Cl. 156/379.6; 428/190

(57) ABSTRACT

An industrial fabric used in the manufacture or processing of at least one material web includes a base fabric having a board side and a machine side. The base fabric includes a plurality of spirals extending in a cross machine direction (CMD). The spirals are interconnected together with each other along adjacent peripheral edges to form a spiral link fabric. The base fabric has opposite lateral side edges extending in a machine direction (MD). One or more electrostatic control yarns are positioned within a corresponding spiral and extend in the CMD direction to the lateral side edges. A pair of conductive edge coatings are applied to at least the board side of a respective lateral side edge for a predetermined width. The conductive edge coatings and the one or more electrostatic control yarns form an electrostatic grid. A pair of wear resistant coatings are applied to an area adjacent a respective conductive edge coating such that a substantially constant spacing between the wear resistant coatings corresponds to a minimum expected working width of the industrial fabric. The wear resistant coatings are wear resistant with a hardness of between approximately 50 to 66 Shore A Durometer Hardness, and a coefficient of friction greater than approximately 2 on the board side. The industrial fabric has a completely non-marking seam because of its integral nature with the base fabric and the equal amount of the wear resistant coating at the seam and the edges.

### BACKGROUND OF THE INVENTION

1. Field of the Invention

The present invention relates to papermaking, and relates more specifically to corrugator “top belt” fabrics employed in making corrugated paper board, or box-board on a double-backer boxboard machine.

2. Description of the Related Art

During the fabrication and use of most fabrics manufactured with monofilament yarns, static electricity can build-up. The result of static electricity build-up is the occasional spontaneous electrostatic discharge (ESD). An ESD can not only damage the paper constructed product in production, but also irreparably damage the fabric used in the fabrication of the paper constructed product. This can lead to costly replacement of the fabric and down time for the manufacturing apparatus. In the worst case scenario, the machine fabricating the paper constructed product can be damaged, or initiation of a fire could result.

An example of a paper constructed product is corrugated box-board. On a corrugator box-board machine there is a transformation from sheets of linerboard paper and corrugating medium paper into corrugated box-board. This is achieved by the application of a liquid adhesive (starch) to the three sheets of paper. This is normally formed by corrugating medium paper sandwiched between two sheets of corrugating linerboard paper and pressing together by one or more corrugator belts, woven or needled, or a combination thereof onto a series of steam-heated plates. In a typical corrugator machine, the heating zone comprises a series of steam-heated plates to dry the adhesive thereby “gluing” the paper assembly together, and the sheet of corrugated board is pulled by the corrugator belt. A plurality of weighted rollers or other roller less weight systems, such as spring loaded metals “shoes” within the endless loop formed by the corrugator belt press the corrugator belt toward the hot plates, so that the corrugator belt may pull the sheet across the hot plates under a selected amount of pressure. The weighted rollers or “shoes” ensure that the sheet will be firmly pressed against the hot plates, and that frictional forces between the corrugator belt and the sheet will be sufficiently large to enable the belt to pull the sheet. As well as this drying function, the belt must pass the corrugated box-board through the cooling section and onto the next stage.

Corrugator belts are generally woven or woven base and then needled, fabrics, each of which is fabricated to size or trimmed in the lengthwise and widthwise directions to a length and width appropriate for the corrugator machine on which it is to be installed. The ends of the fabrics are provided with a seam, so that they may be joined to one another with a pin, pintle, or cable when the corrugator belt is being installed on a corrugator machine.

Contemporary fabrics are produced either by being woven or needled and joined at the seam with metal clipper hooks to form an endless loop on the machine. These metal hooks are not an integral part of the corrugator belt and this can create several problems. The biggest problem can be marking of the boxboard being produced especially on boxboard constructed with e-flute or finer corrugating medium. This marking causes considerable waste and/or subsequent printing problems. Other problems caused by the metal hooks can be the fracture of the clipper hooks and mechanical wear and the subsequent damage to the corrugator machine components resulting from the clipper hooks themselves. The woven or needled felt that accommodates these clipper hooks is required to be quite dense to anchor these clipper hooks adequately. Because these materials are so dense they are consequently very low in permeability which prevents steam vapor from passing through the corrugator belt material. This, in turn slows down the bonding process and therefore the speed of the corrugator machine. These metal hooks are not an integral part of the corrugator belt and therefore need to be covered with a flap or fibers and this can create several problems. The biggest problem can be marking of the boxboard being produced especially on boxboard constructed with e-flute or finer corrugating medium.

As implied above, a corrugator belt takes the form of an endless loop when installed on a corrugator machine. In such form, the corrugator belt has a face, or board side, which is the outside of the endless loop, and a machine side, which is the inside of the endless loop. Frictional forces between the machine side of the belt and the drive rolls of the corrugator machine move the corrugator belt, while frictional forces between the face side of the top and bottom corrugator belts pull the corrugated boxboard sheet through the machine and onto the next process.

Corrugator belts should be strong and durable, and should have good dimensional stability under the conditions of tension and high temperature encountered on the machine. The belts must also be comparatively flexible in the longitudinal, or machine, direction, while having sufficient rigidity in the cross-machine direction to enable them to be guided around their endless paths. It is a huge advantage and desirable for the belts to have porosities sufficient to permit vapor to pass freely through, while being sufficiently incompatible with moisture to avoid the adsorption of condensed vapor which might rewet the surfaces of the corrugated paper product.

### SUMMARY OF THE INVENTION

The present invention provides a fabric including a spiral base fabric wherein the fabric comprises a non-marking spiral seam integrated with the body of the fabric, i.e., the seam and the base fabric are essentially the same. The base fabric incorporates conductive yarns and the edges are coated for 1″ with conductive adhesive to complete the conductive grid. Furthermore, silicon is custom coated on the board side edges (between the 1″ conductive edges). Custom coated for the narrowest boards produced, e.g., an 88″ wide belt and a presumed narrowest board of 48″, then the coating will be 20″ on each edge (1″ for the conductive adhesive and 19″ for the silicon). The silicon coating is flush with the surface of the fabric so that it does not mark the board and is soft and supple yet hard wearing. The silicon also helps pull the board through the machine at start-ups and after board breaks.

The invention in one form is directed to a monofilament base fabric incorporating conductive yarns and conductive edging, to complete the conductive grid. This fabric can provide one or more of the following advantages: heat and hydrolysis resistant materials, providing light weight high strength fabrics, having a high permeability in the central portion of the fabric, a surface with a high coefficient of friction due to the silicon coated edges on the board side of the belt. The present invention also relates to an integrated spiral loop seam integrated with the base fabric which can provide one or more of the following advantages: be an extremely stable and yet flexible corrugator fabric, with superior heat and hydrolysis resistance and the ability to provide a non-marking loop seam, and board pulling power due to the silicon coated edges. The base fabric is a conductive spiral fabric that is coated on the board side edges of the fabric with a silicon rubber compound. This provides the high traction (high coefficient of friction) required. This characteristic is desired in a corrugator belt to pull the corrugated boxboard through the machine without any slippage. The non-marking seam is another desirable feature that this belt possesses. Further, because of the base structure, if the fabric is damaged in use then that particular damaged section can be removed and the fabric joined back together again and production is resumed relatively quickly. The conductive nature of the base fabric is required to prevent “shocking” of nearby personnel and also prevents fires that can be easily ignited in this environment with an electronic spark. This lighter weight design also requires less amperage from the drive motor which is additional energy savings. Also, the monofilament/silicon structure requires less cleaning because it repels the starch that is prevalent during the manufacture of boxboard. This is also an economic advantage over traditional belts.

The invention in another form is directed to an industrial fabric used in the manufacture or processing of at least one material web. The industrial fabric includes a base fabric having a board side and a machine side. The base fabric includes a plurality of spirals extending in a cross machine direction (CMD). The spirals are interconnected together with each other along adjacent peripheral edges to form a spiral link fabric. The base fabric has opposite lateral side edges extending in a machine direction (MD). One or more electrostatic control yarns are positioned within a corresponding spiral and extend in the CMD direction to the lateral side edges. A pair of conductive edge coatings are applied to at least the board side of a respective lateral side edge for a predetermined width. The conductive edge coatings and the one or more electrostatic control yarns form an electrostatic grid. A pair of wear resistant coatings are applied to an area adjacent a respective conductive edge coating such that a substantially constant spacing between the wear resistant coatings corresponds to a minimum expected working width of the industrial fabric. The wear resistant coatings are wear resistant with a hardness of between approximately 50 to 66 Shore A Durometer Hardness, and a coefficient of friction greater than approximately 2 on the board side.

In view of the description noted above, the corrugator belt of the present invention possesses certain features such as strength, durability, dimensionally stable, and has a non-marking seam under all the conditions of high temperature steam, plus high tension. Furthermore, the belts are flexible in the machine direction yet sufficiently stable in the cross machine direction so as to maintain close to the belt's original dimensions and facilitate the ability to be guided along its passage around the machine under the conditions described. More importantly, the belts are sufficiently permeable to allow the evaporation of vapor to pass easily through the material so as not to rewet the corrugated box-board. Also, a non-marking seam, of the same caliper of the base fabric is desired, as in this case. Plus, silicon coated edges are provided to protect the exposed top belt when the board is narrower than the fabric, e.g., the top belt is 88″ wide and the narrowest board produced on a particular machine is 48″ wide, then the edges will be coated with silicon for 20″ on each board side. On the very edge, conductive adhesive such as F-611 from Plastidip is applied to form the conductive grid with the conductive yarns in the center of the spirals.

However, corrugator belts exhibiting all of the above desirable features have heretofore not been available. Conventional corrugator belts exhibited low permeability and used the principle of absorption and then evaporation but problems of rewetting the corrugated box-board occurred which means the corrugator machine was restricted to speed because drying was being restricted. Moreover, these types of belts were typically heavy and very low in permeability. Or, if a more open design, i.e., higher permeability compared to traditional corrugator belts was employed, the board side edges were not protected from the wear that occurs from the exposed fabric to the hot plates and dried glue/starch that makes a sandpaper-like environment which leads to premature wear removal or poor edge bonding because the caliper of the fabric at the edges is smaller than the central portion of the fabric.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a fragmentary, perspective view of a portion of a base fabric which may be used with the industrial fabric of the present invention; and

FIG. 2 is a schematic, perspective view of an embodiment of the industrial fabric of the present invention.

Corresponding reference characters indicate corresponding parts throughout the several views. The exemplification set out herein illustrates an embodiment of the invention, in one form, and such exemplification is not to be construed as limiting the scope of the invention in any manner.

### DETAILED DESCRIPTION OF THE INVENTION

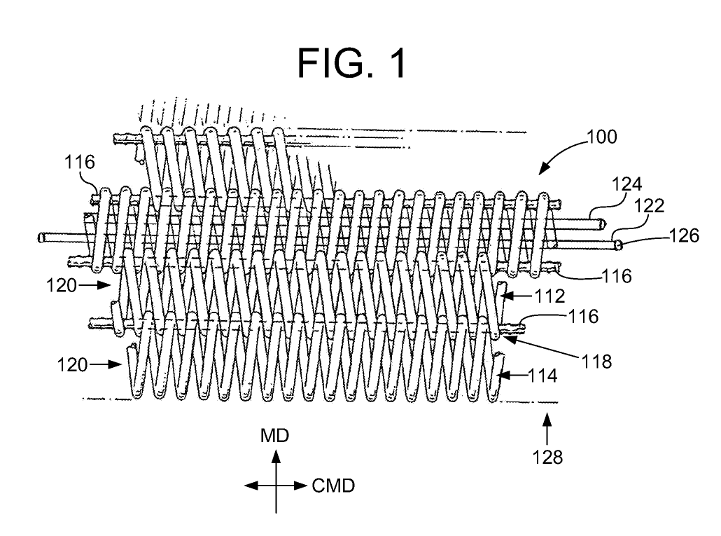

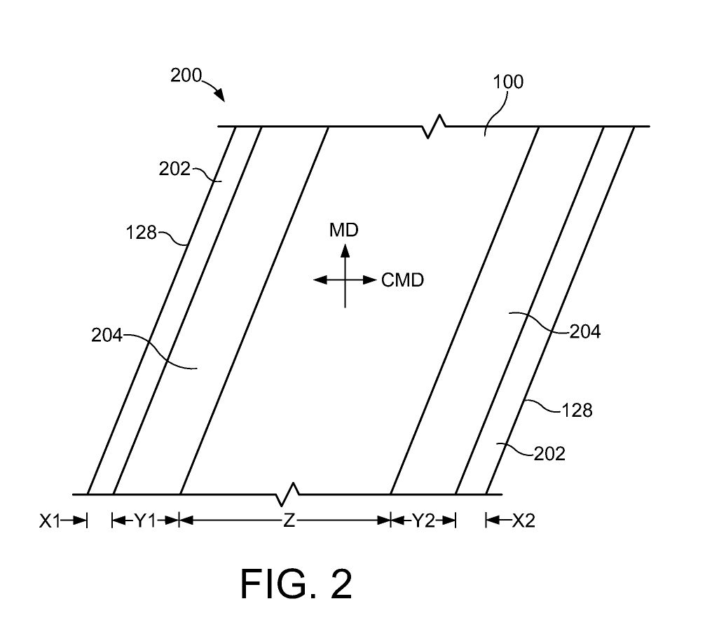

Referring now to the drawings, and more particularly to FIG. 1, there is shown a plan view of a portion of a spiral link base fabric 100 which may be used with the industrial fabric 200 (FIG. 2) according to the present invention. The basic construct of the base fabric 100 shown in FIG. 1 is likewise shown in FIG. 2 of U.S. Pat. No. 7,425,364 (Harwood et al.), which is assigned to the assignee of the present invention and incorporated herein by reference. Preliminarily, it is noted that while the discussion of the present invention may refer specifically to corrugator belts, more specifically to top corrugator belts, the present invention has applicability to other fabrics in the industrial textile and other industrial applications.

Base fabric 100 includes a plurality of spirals (or coils) 112, 114 extending in a cross machine direction (CMD). Spirals 112, 114 have opposite longitudinal ends defining respective lateral side edges 128 extending in a machine direction (MD) of base fabric 100. (It should be appreciated that spirals 112, 114 are shown in fragmentary form in FIG. 1, and side edges 128 are better seen in FIG. 2). The plurality of spirals 112, 114 may be comprised of a suitable material, such as a monofilament polyester, or more specifically polyethylene terephthalate (PET), polyetheretherketone (PEEK), polyphenylene sulfide (PPS) or thermoplastic copolyesters (PCTA).

Spirals 112, 114 include a filament with a diameter of between approximately 0.50 mm to 1.00 mm. Spirals 112, 114 are interconnected together with each other along adjacent peripheral edges to form a spiral link fabric. More particularly, spirals 112, 114 are connected by interdigitating adjacent spirals and inserting a connecting pin (or pintle) 116 into the indigitated region 118. An open channel 120 is thereby created between the connecting rods 116 within each spiral 112, 114. Connecting pins may have a diameter, e.g., of between approximately 0.50 mm to 1.00 mm.

The open channel, or region 120 located between the connecting rods 116 may be stuffed with at least one antistatic control yarn 122. This at least one antistatic control yarn 122 is removably attached to the spiral link fabric 100. The at least one antistatic control yarn 122 can be a conductive monofilament, a conductive multifilament, a conductive metal, a conductive foam, and/or any other conductive yarn that can be placed in one of the open channels. In one embodiment, the antistatic control yarn 122 is a carbon impregnated polyarnide.

When the at least one antistatic control yarn 122 is a monofilament, it may have a diameter between approximately 0.1 mm to approximately 1.0 mm, preferably between approximately 0.28 mm to 0.90 mm, and more preferably approximately 0.52 mm. When the at least one antistatic control yarn 122 is a multifilament, it may have a diameter ranging between approximately 22 dTex and approximately 1500 dTex. Still further, the cross section of the antistatic control yarn 122 can be either a round cross section or a profiled cross section. A profiled cross section is any geometric shape that is not round or circular. For example, a profiled cross section can be oval, square, diamond or polygonal. When a plurality of the antistatic control yarns 122 are used, these antistatic control yarns 122 are preferably regularly spaced among the open channels 120 in the base fabric 100.

Adjacent to the antistatic control yarn 122 is optionally placed a permeability control yarn 124. Each permeability control yarn 124 is preferably collocated with a corresponding antistatic control yarn 122 in the open channel 120. Stated differently, each permeability control yarn 124 can be placed side-by-side with an antistatic control yarn 122, as shown in FIG. 1, or the two yarns 122, 124 can be twisted or otherwise attached to each other. In one embodiment, the permeability control yarns 124 are a polyester monofilament or a multifilament. The diameter of the permeability control yarn 124 is selected to determine the permeability of base fabric 100.

Referring now to FIG. 2, industrial fabric 200 includes a conductive edge coating 202 which is applied to each lateral side edge 128 and connects the opposite longitudinal ends 126 of the antistatic control yarns 122 with the opposite longitudinal ends of the helical spirals 112, 114. The conductive edge coating 202 acts as a bus bar, electrically connecting the one or more antistatic control yarns 112, 114 to form a conductive grid, thereby dissipating any ESD. The conductive edge coating 202 can be a heat seal adhesive that bonds the edges of the antistatic control yarns 122 with the longitudinal ends of the spirals 112, 114 of base fabric 100. This adhesive can be, for example, a carbon impregnated adhesive. The coating or adhesive, in one embodiment, is made from a conductive carbon impregnated synthetic compound, such as carbon particles suspended in latex.

Conductive edge coating 202 is applied at least to the board side of the base fabric 100, but can also be applied to the machine side of the base fabric too, depending upon the application. Conductive edge coating 202 is applied to base fabric 100 for a predetermined width. In one embodiment, each conductive edge coating is applied to base fabric 100 with a common width of 1 inch, represented by the references symbols X1 and X2, but could have a different width, depending on the application. Further, the dimensions for X1 and X2 can be the same as shown, or can be different from each other, depending on the application.

The terms “board” side and “machine” side, as used herein and known in the art, are intended to mean the side of the base fabric which carries the material web and the side that contacts the machine, respectively. Other terms such as “paper” side or “web” side, etc are also known in the art and considered synonymous terms with the board side.

Base fabric 100 also includes a pair of wear resistant coatings 204. Each wear resistant coating 204 is applied to an area adjacent a respective conductive edge coating 202 such that a substantially constant spacing Z between wear resistant coatings 204 corresponds to a minimum expected working width of industrial fabric 200. In other words, the minimum expected working width corresponds to the minimum expected board or web size to be manufactured or processed using industrial fabric 200. In one embodiment, wear resistant coatings are applied to base fabric 100 with a common width of 19 inches, represented by the reference symbols Y1 and Y2, but could have a different width, depending on the application. Further, the dimensions for Y1 and Y2 can be the same as shown, or can be different from each other, depending on the application.

In the illustrated embodiment, wear resistant coatings 204 have the following physical properties:
a hardness of between approximately 50 to 66 Shore A Durometer Hardness, preferably approximately 58 Shore A Durometer Hardness,
a coefficient of friction greater than approximately 2 on the board side, and greater than approximately 0.15 on the machine side (if applied to the machine side),
a thickness of between approximately 1 to 8 mm, corresponding generally to a caliper of the base fabric (in other words, extending from the machine side to the board side of the base fabric 100),
a tensile strength of between approximately 130 to 150 N/mm², preferably approximately 140 N/mm²,
approximately 220% elongation @ break,
a temperature range of between approximately +204° C. to −60° C., and
a tear strength of between approximately 14 to 18 N/mm², preferably approximately 16 N/mm².

From the foregoing, it maybe be observed that two important physical characteristics of wear resistant coating 204 are hardness providing a good wear resistance, and a relatively high coefficient of friction which allows industrial fabric 200 to pull the board through the machine. In one embodiment, wear resistant coating 204 is a rubber, preferably a silicon rubber, with the above mentioned physical properties. However, wear resistant coating 204 could be a different type of coating material with the aforementioned physical properties.

Base fabric 100 has an uncoated permeability of between approximately 500 to 1200 cubic feet per minute (CFM) in an area corresponding to the minimum expected working width Z between wear resistant coatings 204. Preferably, base fabric 100 has a permeability of between approximately 900 to 1200 CFM in the area corresponding to the minimum expected working width Z. The permeability of industrial fabric 200 in this area Z can be reduced depending on the selected diameter of the antitstatic control yarns 122 to reduce the permeability of the base fabric to between, e.g., approximately 100 to 900 CFM, and in one embodiment to approximately 500 CFM.

### Example 1

A fabric was manufactured for a corrugator machine and was constructed using a 0.90 mm diameter polyester spiral and 0.90 mm diameter hinge pin. It was stretched and heat set at 48 pli and 210° C. After that it was measured, electrostatic control yarns of 0.52 mm diameter (nylon impregnated with carbon) were inserted into the spirals. Then cut to finished size for the customer's corrugator machine and then edge coated for 1″ with conductive carbon impregnated synthetic rubber. The board side edges were then coated with liquid rubber compound on the board side of the fabric for a total of 20″ in total from each edge (19″ silicon, 1″ of conductive adhesive). The silicon rubber compound was then heat cured at 175° C. at 48 pli.

It is noted that the foregoing example has been provided merely for the purpose of explanation and are in no way to be construed as limiting of the present invention. While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An industrial fabric used in the manufacture or processing of at least one material web, said industrial fabric comprising:
a base fabric having a board side and a machine side, said base fabric including a plurality of spirals extending in a cross machine direction (CMD), said spirals being interconnected together with each other along adjacent peripheral edges to form a spiral link fabric, said base fabric having opposite lateral side edges extending in a machine direction (MD);
at least one electrostatic control yarn, each said electrostatic control yarn being positioned within a corresponding said spiral and extending in the CMD direction to said lateral side edges;
a pair of conductive edge coatings, each said conductive edge coating applied to at least said board side of a respective said lateral side edge for a predetermined width, said conductive edge coatings and said at least one electrostatic control yarn forming an electrostatic grid; and
a pair of wear resistant coatings, each said wear resistant coating applied to an area adjacent a respective said conductive edge coating such that a substantially constant spacing between said wear resistant coatings corresponds to a minimum expected working width of said industrial fabric, said wear resistant coating being wear resistant with a hardness of between approximately 50 to 66 Shore A hardness, and a coefficient of friction greater than approximately 2 on said board side.

2. The industrial fabric of claim 1, wherein said wear resistant coating has a thickness of between approximately 1 to 8 mm, corresponding generally to a caliper of the base fabric.

3. The industrial fabric of claim 1, wherein said wear resistant coating is a rubber.

4. The industrial fabric of claim 3, wherein said rubber is a silicon rubber.

5. The industrial fabric of claim 1, wherein said wear resistant coating has a tensile strength of between approximately 130 to 150 N/mm², approximately 220% elongation @ break, an operating temperature range of between approximately +204° C. to −60° C., and a tear strength of between approximately 14 to 18 N/mm².

6. The industrial fabric of claim 5, wherein said wear resistant coating has a hardness of approximately 58 Shore A Hardness, a tensile strength of approximately 130 N/mm², and a tear strength of approximately 16 N/mm².

7. The industrial fabric of claim 1, wherein said spirals are monofilament polyester spirals lying adjacent each other in the MD direction, said spirals being interconnected to each other with a plurality of connecting pins extending in the CMD direction, said base fabric having a permeability of between approximately 500 to 1200 cubic feet per minute (CFM) in an area corresponding to said minimum expected working width.

8. The industrial fabric of claim 7, wherein said base fabric has a permeability of between approximately 900 to 1200 cubic feet per minute (CFM) in said area corresponding to said minimum expected working width.

9. The industrial fabric of claim 7, wherein the spirals include a filament with a diameter of between approximately 0.50 mm to 1.00 mm.

10. The industrial fabric of claim 7, wherein the connecting pins have a diameter of between approximately 0.50 mm to 1.00 mm

11. The industrial fabric of claim 1, including a plurality of permeability control yarns, each said permeability control yarn positioned within a corresponding said spiral and reducing a permeability of said base fabric.

12. The industrial fabric of claim 1, wherein each said antistatic control yarn is comprised of nylon impregnated with carbon.

13. The industrial fabric of claim 12, wherein each said antistatic control yarn has a diameter of between approximately 0.28 mm to 0.90 mm.

14. The industrial fabric of claim 13, wherein each said antistatic control yarn has a diameter of approximately 0.52 mm.

15. The industrial fabric of claim 12, wherein said plurality of antitstatic control yarns reduce the permeability of the base fabric to between approximately 100 to 900 cubic feet per minute (CFM).

16. The industrial fabric of claim 15, wherein said plurality of antistatic control yarns reduce the permeability of the base fabric to approximately 500 CFM.

17. The industrial fabric of claim 1, wherein said wear resistant coatings are also applied to said machine side of said base fabric, said wear resistant coatings having a coefficient of friction greater than approximately 0.15 on said machine side.

18. The industrial fabric of claim 1, wherein each said conductive edge coating is comprised of a conductive carbon impregnated synthetic compound with a width of approximately 1 inch in the (MD) machine direction.

19. The industrial fabric of claim 1, wherein said plurality of spirals are a monofilament comprised of one of polyethylene terephthalate (PET), polyetheretherketone (PEEK), polyphenylene sulfide (PPS) and thermoplastic copolyesters (PCTA).

20. The industrial fabric of claim 1, wherein said base fabric has a caliper of between approximately 1 mm to 8 mm.

21. The industrial fabric of claim 20, wherein said base fabric includes a seam area extending in the CMD direction, and said base fabric has a caliper which is substantially the same in each of the seam area, the wear resistant coatings, and an uncoated area between the wear resistant coatings.

22. An industrial fabric used in the manufacture or processing of at least one material web, said industrial fabric comprising:
a base fabric having a board side and a machine side, said base fabric including a plurality of spirals extending in a cross machine direction (CMD), said spirals being interconnected together with each other along adjacent peripheral edges to form a spiral link fabric, said base fabric having opposite lateral side edges extending in a machine direction (MD), said base fabric having an uncoated permeability of between approximately 500 to 1200 cubic feet per minute (CFM);
at least one electrostatic control yarn, each said electrostatic control yarn being positioned within a corresponding said spiral and extending in the CMD direction to said lateral side edges;
a pair of conductive edge coatings, each said conductive edge coating applied to at least said board side of a respective said lateral side edge for a predetermined width, said conductive edge coatings and said at least one electrostatic control yarn forming an electrostatic grid; and
a pair of wear resistant coatings, each said wear resistant coating applied to an area adjacent a respective said conductive edge coating such that a substantially constant spacing between said wear resistant coatings corresponds to a minimum expected working width of said industrial fabric, said wear resistant coating having the following physical properties:
a hardness of between approximately 50 to 66 Shore A Durometer Hardness,
a coefficient of friction greater than approximately 2 on said board side,
a thickness of between approximately 2 to 8 mm,
a tensile strength of between approximately 130 to 150 N/mm²,
approximately 220% elongation @ break,
a temperature range of between approximately +204° C. to −60° C., and
a tear strength of between approximately 14 to 18 N/mm².

23. The industrial fabric of claim 22, wherein said wear resistant coating is a silicon rubber.

24. A corrugator boxboard machine, including a top corrugator belt and a bottom corrugator belt, at least one of said top corrugator belt and said bottom corrugator belt comprising:
a base fabric having a board side and a machine side, said base fabric including a plurality of spirals extending in a cross machine direction (CMD), said spirals being interconnected together with each other along adjacent peripheral edges to form a spiral link fabric, said base fabric having opposite lateral side edges extending in a machine direction (MD);
at least one electrostatic control yarn, each said electrostatic control yarn being positioned within a corresponding said spiral and extending in the CMD direction to said lateral side edges;
a pair of conductive edge coatings, each said conductive edge coating applied to at least said board side of a respective said lateral side edge for a predetermined width, said conductive edge coatings and said at least one electrostatic control yarn forming an electrostatic grid; and
a pair of wear resistant coatings, each said wear resistant coating applied to an area adjacent a respective said conductive edge coating such that a substantially constant spacing between said wear resistant coatings corresponds to a minimum expected working width of said industrial fabric, said wear resistant coating being wear resistant with a hardness of between approximately 50 to 66 Shore A Durometer Hardness, and a coefficient of friction greater than approximately 2 on said board side.

25. The corrugator boxboard machine of claim 24, wherein said at least one of said top corrugator belt and said bottom corrugator belt comprises said top corrugator belt.
